(19) United States
(12) Patent Application Publication
(10) Pub. No.: US 2003/0106370 A1
(43) Pub. Date: Jun. 12, 2003

(54) Measuring apparatus

(76) Inventors: David Fearnside, Bradford (GB); Terry Smollen, Bradford (GB); Marc Lupton, Bradford (GB); Simon Tait, Sheffield (GB); Peter Skipworth, Sheffield (GB); Tom Howes, Sheffield (GB); Darren Unwin, Sheffield (GB)

Correspondence Address: VENABLE, BAETJER, HOWARD AND CIVILETTI, LLP, P.O. BOX 34385, WASHINGTON, DC, 20043-9998, US

(21) Appl. No.: 10/225,489

(22) Filed: Aug. 22, 2002

(30) Foreign Application Priority Data
Aug. 23, 2001 (GB) 0120533.5

(51) Int. Cl. G01F 17/00

(52) U.S. Cl. 73/149

(57) ABSTRACT

Apparatus for measuring the volume of a fluid passing through a container comprises container motion detection means which detection means is operable to detect motion of the container, and processing means operable to determine the volume of fluid flowing through the container, based on output of the container motion detection means.

The present invention relates to measuring apparatus and particularly, although not exclusively relates to apparatus for measuring flow rates of fluids into, and out of, waste water treatment works.

The United Kingdom Environment Agency has proposed that companies providing water to regions around the UK should be able to measure the volume of water which is discharged on a daily basis from small waste water treatment works (WwTW) to an accuracy of ±8%, where the daily totalised flow volume (DTFV) is estimated to be between 5 m³ and 50 m³. It has been estimated that Yorkshire Water Services have several hundred small wastewater treatment works that would fall into this category. At smaller wastewater treatment works, where the volume of water discharged is less than 5 m³ per day, these measurements will not necessarily be continuous but may be requested by the Environment Agency for discreet periods.

Many of these small wastewater treatment works incorporate installations such as syphons and/or tipping buckets (single sided and double sided). Both of these types of installation distribute settled sewage flows onto filter beds (the syphons via associated distribution arms) before the flows proceed to secondary settlement tanks and then on to a receiving watercourse. It is proposed that these syphons and/or tipping buckets can be used for the measurement of daily totalised flow volume passing through the works.

Traditionally, measurement of flow discharge through these treatment works is carried out by measuring the height difference between water levels in the particular installation i.e. either tipping bucket or syphon. This is carried out by sets of switches inside the installation. The volume of water discharge is then calculated using the knowledge of the installation's dimensions and information on the number of operations.

However, this method has proved to be ineffective since the flow rates cannot be accurately measured or determined due to the intermittent inlet and outlet of fluid to which the installation is subjected. The main disadvantage using this method is that the duration of the syphon or tipping bucket cycle cannot be used to measure flow rates directly. With a syphon, as the flow rate increases, the cycle duration also changes. However, the flow rate is not directly proportional to the cycle duration time. Therefore, when plotting cycle duration against flow rate, a “U”-shaped curve is produced which gives a non-unique solution for flow rate for each cycle period. This means that, for certain cycle periods, two flow rate values are possible or, alternatively, a small variation in time would result in a disproportionately large change in flow rate. Errors with the tipping bucket are associated with the inflow of water when a bucket is discharging.

Therefore, the cycle period for a syphon is heavily dependent on the hydraulic losses from the syphon and other errors associated with flows continuing to enter the container as the syphon is discharging. The errors associated with the tipping bucket are associated with continuing inflow as the bucket discharges and so the timing of the entire cycle to calculate the flow rate is unsuitable. Furthermore, translating the period between switch operations as the water level in the syphon installation drops and water discharges is also considered unsuitable due to the significant hydraulic losses attributed to the distribution arms during part of the cycle of operation. Finally, an extra complication using this method is that the inlet and/or the outlet may become blocked with debris thereby causing the calculations to become inaccurate.

It is one aim of embodiments of the present invention to address the above problems and provide apparatus which measures the flow of discharge at the wastewater treatment works with increased accuracy.

According to a first aspect of the present invention, there is provided apparatus for measuring the volume of a fluid passing through a container, the apparatus comprising first and second fluid level detection means which detection means are operable to detect the presence of said fluid at first and second levels in the container respectively, timing means operable to determine a time of triggering of said first and second fluid detection means, and processing means operable to determine the volume of fluid flowing through the container, based on output of the first and second fluid detection means and said timing means.

According to a second aspect of the present invention, there is provided a method of measuring the volume of fluid flowing through a container, the method comprising the steps of:

(i) detecting times at which fluid in the container reaches first and second levels during filling;

(ii) detecting times at which the fluid in the container reaches either the first or second level during a subsequent filling cycle; and

(iii) computing volume throughput based on the measured times and volume of the container defined by the first and second levels.

The container may comprise a syphon. The syphon may comprise an Adams Hydraulics syphon, or a Tuke and Bell “Blake series” siphon and others. Preferably, the syphon is inserted substantially within the container.

Preferably, said detecting times comprises the use of first and second fluid level detection means. Preferably, the first detection means comprises a lower switch and preferably, the second fluid detection means comprises an upper switch.

The first and second fluid detection means may comprise switches, preferably float switches, operable to detect the level of fluid in the container. Preferably, the detection means are triggered as the level of fluid either covers and/or uncovers the said detection means. Preferably, the timing means is operable to monitor said covering and/or uncovering of said fluid level detection means.

Preferably, the first and second detection means are suitably mounted onto support means. Preferably, the support means comprises a shaft. Preferably, the shaft is arranged in use substantially vertical in the container. Preferably, the first fluid level detection means comprises a lower switch and preferably, the second fluid detection means comprises an upper switch.

Preferably, the first and second fluid level detection means are separated by a separation distance. Preferably, the separation distance is between 5 mm and 300 mm, more preferably, 50 mm and 200 mm, even more preferably, 100 mm and 175 mm and most preferably, 130 mm and 160 mm. In a preferred embodiment, the separation distance is 150 mm.

Preferably, the separation distance is as large as possible depending upon the dimensions of the container.

Preferably, the method comprises determining a filling time of the said container and, preferably a cycle time of the said container. Preferably, the said filling time comprises the time taken for the fluid to cover and thereby trigger the lower switch, and to cover and thereby trigger the upper switch.

Preferably, the said cycle time comprises the time taken for the fluid to cover and trigger the lower switch to cover and trigger the upper switch, then to uncover and trigger the upper and lower switches, and then to cover and trigger the lower switch.

Preferably, said computing comprises determining the ratio of cycle time to filling time and preferably, determining a total of said ratio over the specific time period.

Preferably, said computing comprises determining the volume of the container. Preferably, the computing comprises determining the daily totalised flow volume by multiplying the volume of the container by the total of the ratio of cycle time to filling time. Preferably, said computing assumes substantially constant flow during each cycle.

Advantageously, the apparatus of the present invention may be used to calculate the discharge of fluid from the container. This is achieved by determining the filling time and the cycle duration time. This is far superior to prior art devices and methods for determining volumes and rates of fluid flow which only count the number of cycles and, hence, result in inaccurate measurements.

According to a third aspect of the present invention, there is provided apparatus for measuring the volume of a fluid passing through a container, the apparatus comprising first and second fluid position detection means which detection means are operable to detect the presence of said fluid between first and second positions in the container respectively, timing means operable to determine a time of triggering of said first and second fluid detection means, and processing means operable to determine the volume of fluid flowing through the container, based on output of the first and second fluid detection means and said timing means.

According to a fourth aspect of the present invention, there is provided a method of measuring the volume of fluid flowing through a container, the method comprising the steps of:

(i) detecting times at which fluid in the container reaches first and second positions during filling and emptying;

(ii) detecting times at which the fluid in the container reaches either the first or second position during a subsequent filling cycle; and

(iii) computing volume throughput based on the measured times and volume of the container defined by the first and second positions.

The container may comprise at least one bucket preferably a tipping bucket. The bucket may comprise a single-outlet, single-sided bucket. The bucket may comprise a double-outlet, double-sided bucket. Preferably, the container is positioned substantially over filtration means.

Preferably, the first and second fluid position detection means are suitably mounted onto the bucket preferably at either end thereof. Preferably, the first position detection means is mounted at a first outlet of the bucket and, preferably the second position detection means is mounted at a second outlet of the bucket.

The first and second fluid position detection means may comprise switches, preferably tilt switches, operable to detect the position of fluid in the bucket. Preferably, the detection means are triggered as the position of fluid either covers and/or uncovers the said fluid position detection means. Preferably, the timing means is operable to monitor said covering and/or uncovering of said fluid position detection means.

Preferably, the fluid position detection means are operable to determine the time of filling and emptying the bucket, ie. filling and emptying cycles. Preferably, the fluid position detection means are operable to determine the time during which each cycle the bucket has tipped and is discharging therefrom.

Preferably, the fluid position detection means are operable to determine the position of fluid within the bucket and preferably the position of the bucket in terms of its tilt. Preferably, the processing means is operable to calculate the volume of fluid entering the bucket as fluid exits the bucket via the or each outlet. Preferably, the processing means is operable to calculate the volume of fluid filling the bucket as it exits the bucket via the or each outlet.

Advantageously, and preferably, the apparatus of the third aspect and the method of the fourth take into account the fact that the container is continuously being filled as it is actually being emptied, hence, increasing the accuracy of calculations to determine the flow rate/volume therethrough.

Preferably, the methods of the second and fourth aspects comprise determining the volume of fluid flowing through the container over a defined period of time. The defined period may be any time required by an operator. Preferably, the time period comprises 24 hours. Preferably, the method comprises determining the daily totalised flow volume through the container. Preferably, said computing comprises the use of processing means, preferably a computer.

Preferably, the container is operable to distribute sewage effluent preferably, at a sewage treatment works. Preferably, the fluid comprises sewage effluent and related fluids such as water. Preferably, the container is located downstream of a primary settlement tank and suitably mounted over filtration means. Preferably, the filtration means comprises at least one filter bed.

Preferably, the container comprises at least one inlet and preferably at least one outlet. The container may contain a plurality of outlets preferably operably attached to distribution arms which are preferably, suspended over the said filtration means.

Preferably, the timing means comprises at least one clock. Preferably, the timing means comprises first and second clocks. Preferably, the first clock is operable to determine the time interval during which the fluid moves between said first and second levels and/or positions. Preferably, the second clock comprises a real-time clock preferably, a DS2404S clock.

Preferably, the resolution of the timing means is in the range of 0.001 seconds to 10 seconds, more preferably, 0.015 seconds to 5 seconds, and most preferably, in the range of 0.1 seconds to 2 seconds. In a preferred embodiment, the resolution of the timing means is 1 second.

Advantageously, and preferably, the said resolution of the timing means is sufficiently low to enable the processing means of the apparatus to relatively accurately determine the volume of fluid in the container, and sufficiently high enough to substantially minimise the amount of noise generated by the timing means.

Preferably, the apparatus further comprises at least one switch de-bounce operable to substantially minimise electrical noise generated by the first and second detections means. Preferably, the switch de-bounce comprises a MAX617 circuit.

Preferably, the processing means comprises a micro-processor preferably a computer which comprises data storage means. Preferably, the processing means comprises an Atmel 89LS8252. The processing means may comprise the timing means.

Advantageously, the processing means was chosen to keep power consumption low. Preferably, the processing means comprises hardware support for a “sleep” (power down) mode, and “wake up” on interrupt. Disadvantageously, most other processors require a complete system reset to resume from power down. Since the apparatus will spend most of its time doing nothing, the ability to sleep is a positive advantage. Preferably, the processing means is operable to store data in non-volatile memory.

Preferably, the apparatus is substantially portable.

Preferably, the apparatus is battery powered.

Preferably, the apparatus is operable to operate in “sleep” and “wake-up” modes mode. Advantageously, this serves to minimise the power requirements of the apparatus.

According to a fifth aspect of the present invention, there is provided a computer operable to perform the method of the second aspect.

According to a sixth aspect of the present invention, there is provided a computer operable to perform the method of the fourth aspect.

According to a seventh aspect of the present invention, there is provided a recordable medium operable to carry a computer program operable to perform the method of the second aspect.

According to an eighth aspect of the present invention, there is provided a recordable medium operable to carry a computer program operable to perform the method of the fourth aspect.

According to a ninth aspect of the present invention, there is provided apparatus for measuring the volume of a fluid passing through a container, the apparatus comprising container motion detection means which detection means is operable to detect motion of the container, and processing means operable to determine the volume of fluid flowing through the container, based on output of the container motion detection means.

According to a tenth aspect of the present invention, there is provided a method of measuring the volume of fluid flowing through a container, the method comprising the steps of:

(i) detecting motion of the container;

(ii) computing fluid volume throughput based on the detected motion of the container.

The container may comprise at least one bucket, preferably a tipping bucket. Preferably, the container is positioned substantially over filtration means, preferably by a pivot. Preferably, the container is pivotable along an axis parallel with a longitudinal axis thereof. The container may comprise at least one chamber in which fluid may be contained. The container may comprise a single-outlet, single-sided bucket.

Preferably, the container comprises first and second chambers), preferably separated by dividing means. Preferably, the dividing means comprises a dividing wall which preferably extends substantially parallel with a longitudinal axis of the container. The container may comprise a double-outlet, double-sided bucket.

Preferably, where the container comprises a single chamber or single outlet, the container is adapted to pivot between a first position in which the container is filling with fluid, and a second position in which the container is emptying fluid.

Preferably, where the container comprises first and second chambers or two outlets, the container is adapted to pivot between a first position in which the first chamber is filling with fluid, and a second position in which the first chamber is emptying fluid, and preferably the second chamber is filling with fluid.

Preferably, the container motion detection means is suitably attached to the container preferably, on the dividing means. Preferably, the container motion detection means is adapted to measure the acceleration, preferably, the tilt, and preferably, the roll (angular position), of the container as the container moves between the first and second positions. Preferably, the container motion detection means is adapted to measure angular position of the container to determine movement of the container with respect to time. Preferably, the container motion detection means measures movement of the container about a positive and preferably, a negative X and Y-axis of the container.

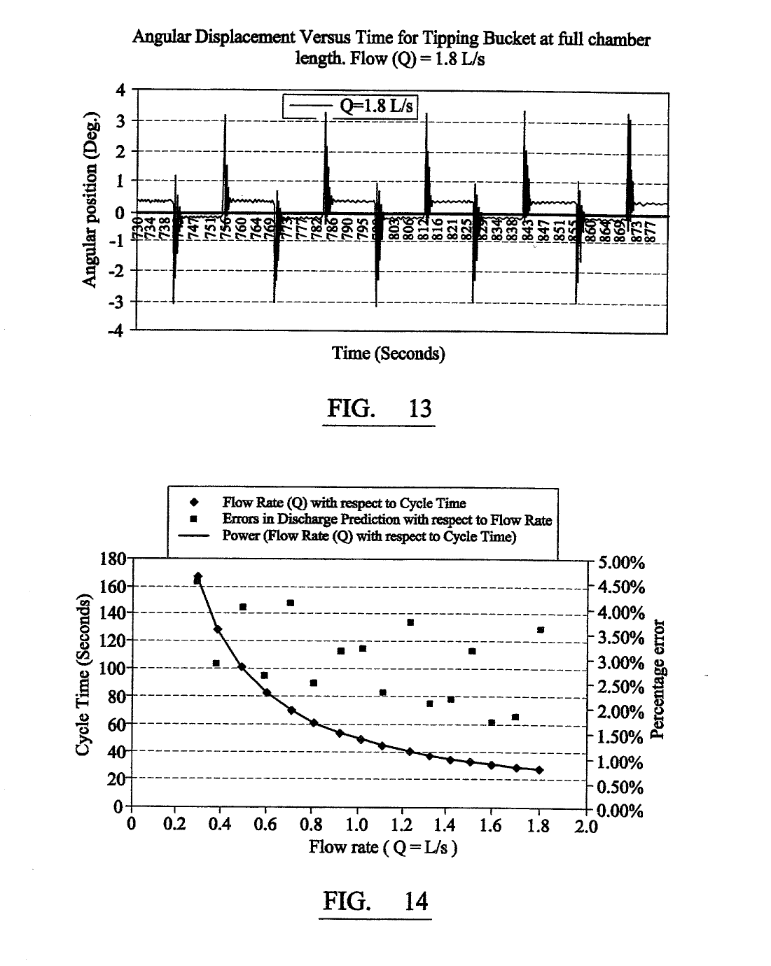

Preferably, the container motion detection means is operable to determine the time of filling and preferably, the time of emptying the bucket, ie. filling and emptying cycles. Preferably, the container motion detection means is operable to determine the time of motion during which the bucket has tipped and is discharging therefrom. The time of motion is the time between the two positions. Preferably, the container motion detection means is operable to determine the time during which the container is filling with fluid, and preferably, the time during which the container is in motion. Preferably, the time during which the container is filling with fluid is illustrated as the time between two peak angular positions as shown in FIG. 13. Preferably, the time during which the container is in motion is illustrated as dt as shown in FIG. 10.

Preferably, the container motion detection means comprises an accelerometer. Preferably, the accelerometer samples at between 10-500 Hz, more preferably 50-250 Hz and, most preferably 100-200 Hz.

Preferably, the processing means is operable to calculate the volume of fluid entering the bucket as fluid exits the bucket via the or each outlet. Preferably, the processing means is operable to calculate the volume of fluid filling the bucket as it exits the bucket via the or each outlet.

Preferably, the container comprises at least one inlet and preferably at least one outlet. The container may contain a plurality of outlets preferably which may be suspended over the said filtration means.

All the features described herein may be combined with any of the above aspects, in any combination.

For a better understanding of the invention, and to show how embodiments of the same may be carried into effect, reference will be made, by way of example, to the accompanying diagrammatic drawings, in which:

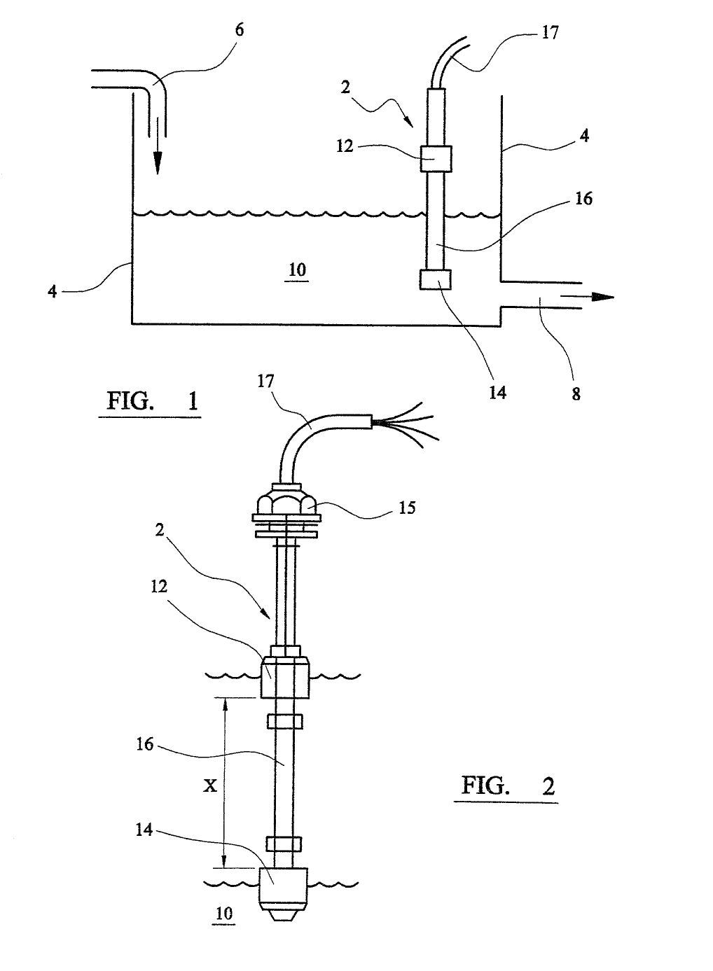

FIG. 1 shows a schematic side view of an apparatus for measuring the daily totalised flow volume through a waste water treatment works;

FIG. 2 shows a schematic side view of a fluid flow measuring device as shown in FIG. 1;

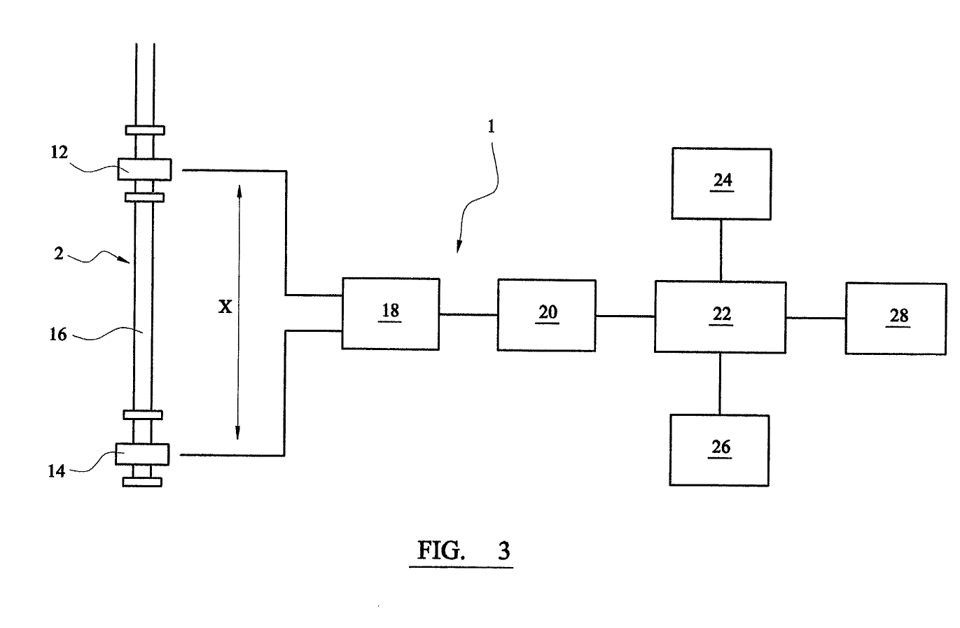

FIG. 3 shows a schematic layout of the fluid flow measuring apparatus;

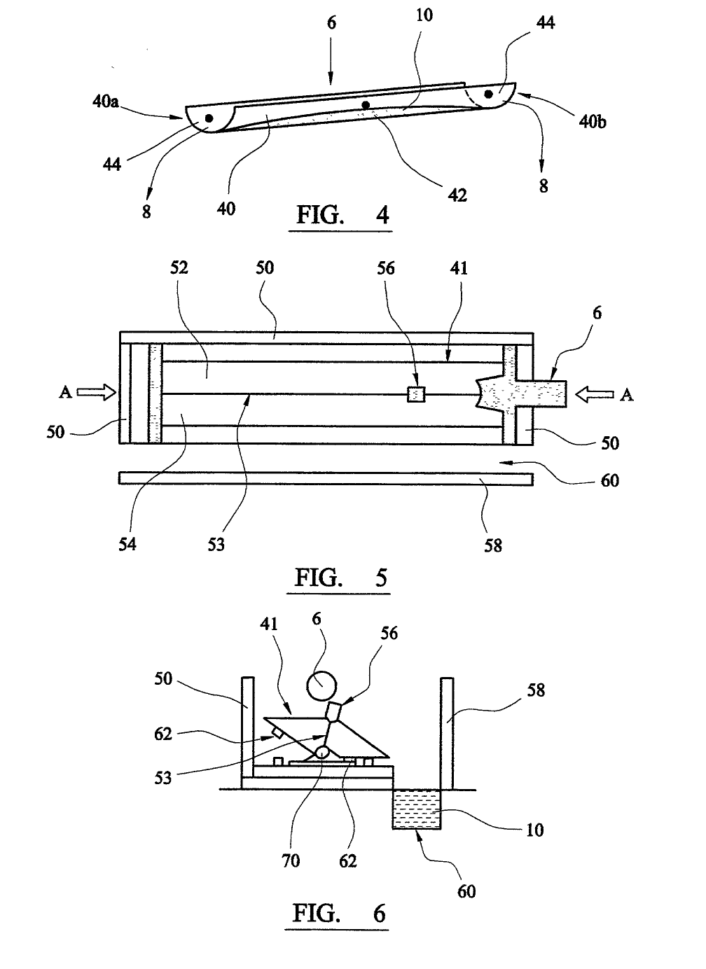

FIG. 4 shows a schematic layout of a first embodiment of a tipping bucket;

FIG. 5 shows a schematic plan view of a second embodiment of a tipping bucket;

FIG. 6 shows a schematic side view of the tipping bucket shown in FIG. 5;

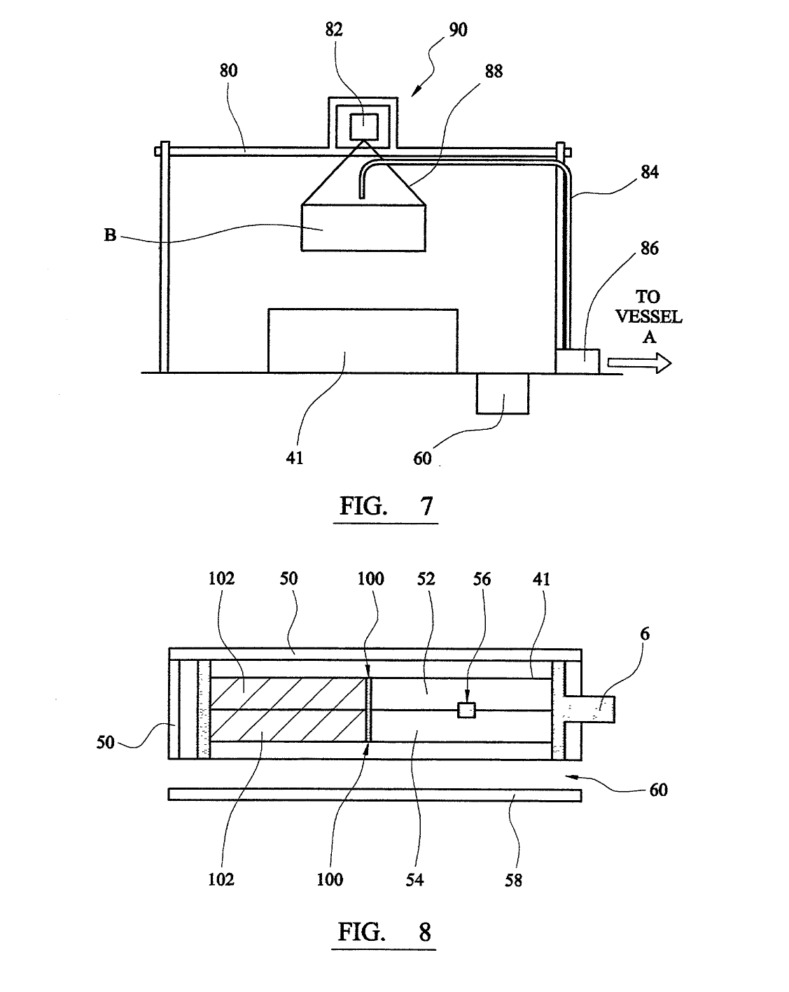

FIG. 7 shows a schematic side view of apparatus used to calibrate the tipping bucket shown in FIGS. 5 and 6;

FIG. 8 shows a schematic plan view of the tipping bucket used for calibration purposes showing a full length bucket and a reduced length tipping bucket;

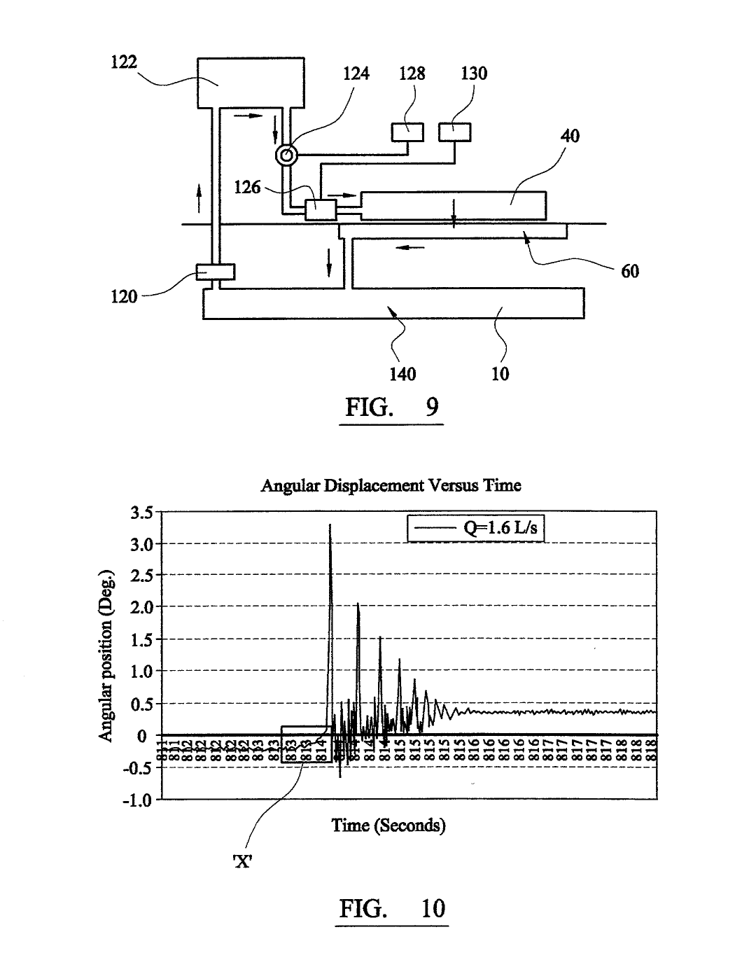

FIG. 9 shows a schematic representation of the tipping bucket apparatus;

FIG. 10 shows a graphical representation of angular position against time for a tipping bucket impact with the period corresponding to dt highlighted;

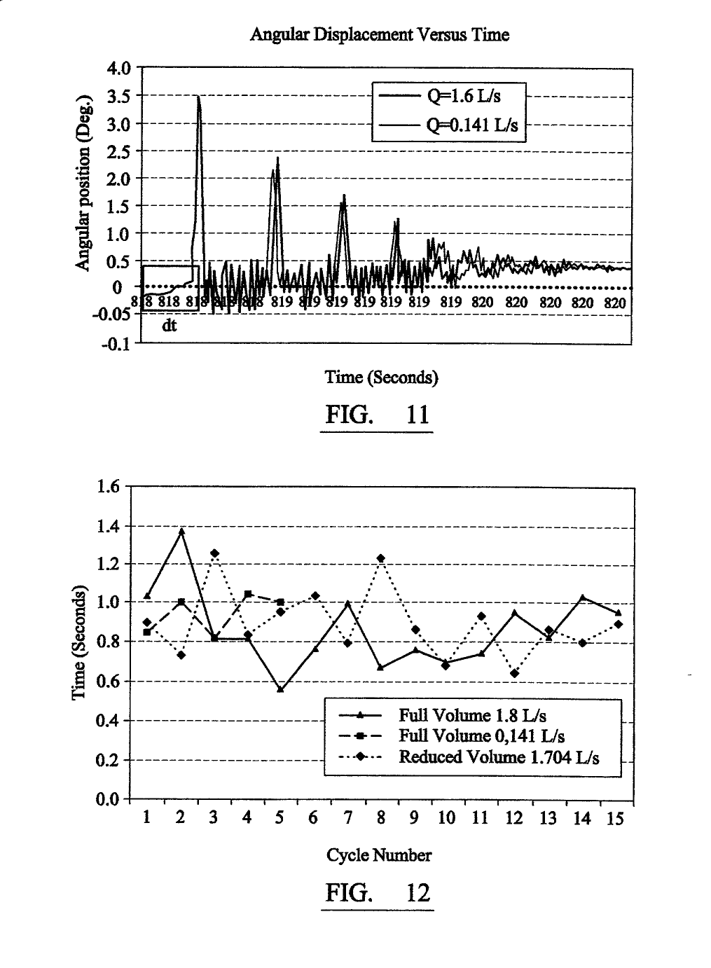

FIG. 11 shows a graphical representation of angular position against time for a double sided tipping bucket showing maximum flow rate plot for the full length bucket, and minimum flow rate for the reduced length tipping bucket shown in FIG. 8;

FIG. 12 shows a graphical representation of estimation of the value of dt for 1.8 and 0.141 l/s for the tipping bucket at full chamber volume, and for 1.704 l/s for the tipping bucket at reduced chamber volume;

FIG. 13 shows a graphical representation of angular position against time for five complete tipping cycles, for a double sided tipping bucket at full chamber volume with flow Q=1.8 l/s;

FIG. 14 shows a graphical representation of cycle time against flow rate and associated errors in discharge prediction for the double sided tipping bucket at full chamber length;

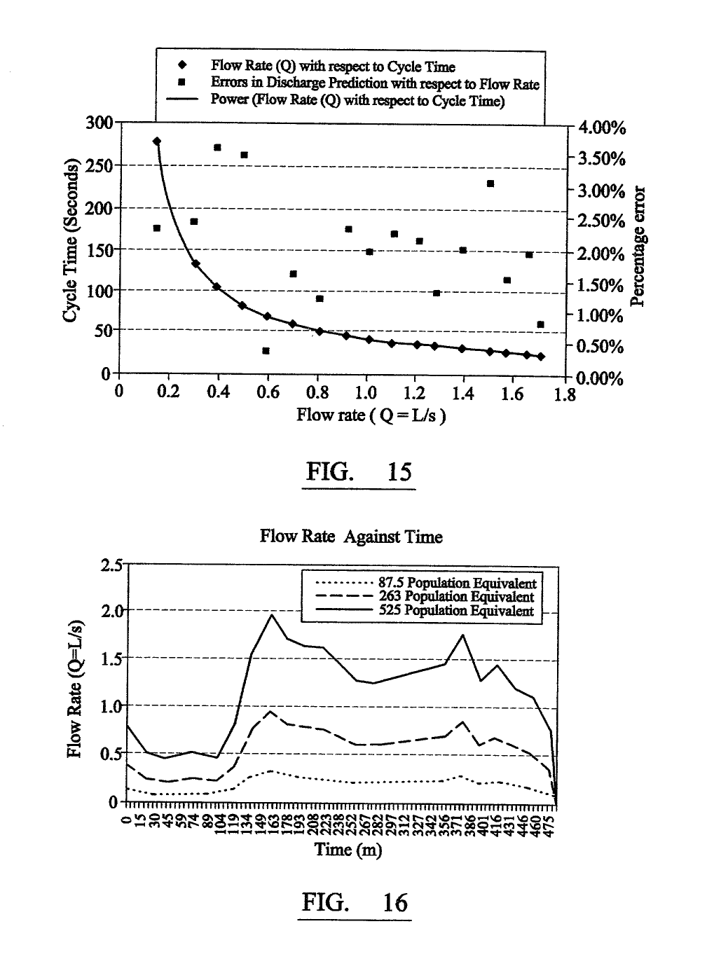

FIG. 15 shows a graphical representation of cycle time against flow rate and associated errors in discharge prediction for the double sided tipping bucket at reduced chamber length; and

FIG. 16 shows a graphical representation of peak flow rate against time for three population equivalents.

Referring to FIG. 1, there is shown a sewage effluent distribution container 4 of a waste water treatment works.

The container 4 is located downstream of a primary settlement tank (not shown) and mounted over a filter bed (not shown). A distribution syphon may be inserted into the container 4 but for illustrative purposes have been omitted from FIG. 1. The use of the syphon depends on the general layout and age of each waste water treatment works (WwTW).

Sewage effluent 10 passes from the primary settlement tank and enters the syphon container 4 via inlet 6. The effluent 10 fills the syphon container 4 until it reaches a pre-determined level at which point the syphon container 4 then ‘flushes’ and exits via outlet 8. This is described as one syphon 4 cycle. For convenience, FIG. 1 illustrates the container 4 being a syphon 4 having a single inlet 6 and a single outlet 8.

The effluent 10 exits the syphon container 4 via outlet 8, along distribution arms (not shown) and onto the filter bed where it is filtered. Once the effluent 10 has passed through the filter bed, it then passes to a secondary settlement tank (not shown) before being discharged into a final receiving watercourse (not shown).

The UK Environment Agency has proposed that companies providing water around the UK should be able to measure the volume of effluent 10 which is discharged on a daily basis from small WwTW's to an accuracy of ±8%, where the daily totalised flow volume (DTFV) is estimated to be between 5 m³ and about 50 m³. It is proposed that these syphon containers 4 and can be used for the measurement of DTFV passing through the WwTW.

Unfortunately, the duration of the syphon container 4 cycle cannot be used to measure effluent 10 flow rate directly because, converse to intuition, as the flow rate increases, the cycle duration also increases, i.e. the flow rate is proportional to the cycle duration time. This produces a “bathtub” or “U”-shaped plot of cycle duration against flow rate, which gives a non-unique solution for each flow rate for a given cycle period, because two values are possible, i.e. either side of the “U”-shape.

The solution to this problem was based on the observation that the filling rate of the container 4 is proportional to the flow rate. Furthermore, if the flow rate is assumed to be constant, then totalised flow can be derived from the ratio of cycle duration to filling time, and factored by a constant which represents the volume of effluent 10 flowing during that filling time. Summation of all such measurements during a full day would then produce the Daily Totalised Flow Volume (DTFV).

Laboratory testing supported this theory and confirmed that a unique solution can be found to the flow rate measurement regardless of size of the outlet aperture, the state of fouling (within reason), or any other effects that may affect the outlet flow. Therefore, assuming constant effluent 10 flow, and constant state of the syphon 4, then effluent 10 flow may be calculated based on the ratio of cycle duration to filling time.

FIG. 1 shows a measuring device 2 in accordance with the present invention, in position inside the syphon container 4. The device 2 is part of a fluid flow measurement apparatus 1 as shown in FIG. 3 with which the DTFV through the waste water treatment works is measured.

Referring to FIG. 2, there is shown a detailed view of the flow measurement device 2. The device 2 consists of a shaft 16 onto which is mounted a lower float switch 14 and an upper float switch 12. In this specific embodiment, the separation distance between the upper float switch 12 and the lower float switch 14 as indicated by arrow X, is 150 mm. However, it should be appreciated that the separation distance X may be varied depending upon the specific dimensions of the container 4 in which the flow measurement device 2 is fitted. Original trials were carried out using a separation distance X of about 50 mm the between lower 14 and upper switches 12. However, research revealed that improved accuracy was achieved if a greater distance X between the two switches 12, 14 was used. The arrangement of the switches 12, 14 of the device 2 of the present invention was arrived at by balancing this requirement against tooling costs.

The device 2 is attached to a cable 17 in which three conductors (high, low and centre taps) are contained. Other essential wires and cables for controlling the device 2 are provided via cable 17. A nylon nut 15 is attached to the upper region of the device 2 in order to protect the cable 17.

Referring to FIG. 3, there is shown a functional diagram of the fluid flow measurement apparatus 1. The apparatus 1 consists of the flow measurement device 2 having the upper 12 and lower 14 float switches which are electrically connected to a MAX6817 switch de-bouncing circuit 18, a timer 20, a DS2404S real-time clock circuit 24 and a micro-processor 22. The micro-processor 22 has memory storage capabilities 28 and a Comms RS232 26 and monitors and logs the opening and closing times of the two switches 12, 14 to a resolution of 1 second as determined by the timer 20. From these times, and from the real-time as determined by the real-time clock circuit 24, the microprocessor 22 calculates the filling and cycle time of the syphon container 4. An algorithm for carrying out the calculation is detailed in Appendix 1.

Practical observations have highlighted flaws in the original algorithm (Appendix 1) used to calculate the DTFV. Unfortunately, the assumption that flow rate is a constant cannot be relied upon. In a worst case, where the syphon 4 fills quickly but then the flow stops before it begins to drain down, the accumulated error over time is substantial. If not taken into account, these errors would prevent the target accuracy (less than 8%) from being achieved.

The solution to this, which is detailed in the software section in Appendix 1, is to subtract the idle time, during which there is no flow, from the total cycle time. Although not a perfect solution, this reduces the error in practical situations to below the threshold 8% target.

A further practical consideration is the apportioning of flow volumes around midnight. As is shown in the software notes in Appendix 1, this is simply pro-rata proportioned according to time before/after midnight. These practical modifications have produced a prototype design that is able to measure DTFV within the prescribed limit of less than 8%.

Referring to FIG. 9, there is shown apparatus used for a tipping bucket 40 which may be used at WwTWs and mounted over a filter bed instead of a syphon and its associated container 4. The apparatus consists of a supply pump 120 which pumps water or effluent 10 from a sump 140 to a constant head tank 122. The water/effluent 10 is then passed via a pre-calibrated flow meter 124, through a computer-controlled valve 126, which sets discharge via a valve control computer 130, and then through the tipping bucket 40 arrangement. Water leaves the tipping bucket 40 via a drainage channel 60 back to the sump 140.

The flow meter 124 manufacturer has specified an accuracy of ±2% of the reading. The meter 124 outputs a digital signal that is logged via data acquisition software 128 so that the flow discharge entering the tipping bucket 40 can be monitored continuously throughout each test. The accuracy of the flow meter 124 is periodically checked via volumetric measuring tanks (not shown) which form part of the re-circulating system. Any steady flow rate or time varying pattern of discharge can be specified via control software which controls the operation of the inlet valve.

Referring to FIG. 4, there is shown a first embodiment of the tipping bucket 40. The tipping bucket 40 can either be single-sided or double-sided. However, for illustration purposes, the bucket 40 shown in FIG. 4 is double sided having two ends 40a, 40b. Effluent 10 is directed towards the bucket 40 via inlet 6. The bucket 40 fills with effluent 10 until such a time that the volume and, hence, weight of the fluid 10 causes the bucket 40 to tip about pivot 42. The effluent then leaves the bucket 40 via outlet 8 of which, in this example, there are two, i.e. two ends 40a, 40b, and onto a filter bed (not shown).

The problem with determining the volume of effluent 10 which passes through such an arrangement is that, as the bucket 40 tips and effluent 10 exits via either of the two ends 40a, 40b, effluent 10 still flows via the inlet 6 into the bucket 40. Hence, calculating the volume of flow through the bucket 40 which only account for the number of ‘tips’, i.e. the bucket cycle time, are inaccurate. This may be avoided as follows.

The bucket 40 has been fitted with tilt switches 44 at either end 40a, 40b thereof. The tilt switches 44 are arranged in use to detect the fluid 10 as it fills up the bucket 40. The timing of the triggering of the switches 44, the volume of the bucket 40, and the timing of tips are used to calculate the flow rate. The data monitored by the switches 44 is logged by a similar arrangement as in the apparatus 1 shown in FIG. 3, ie. the switch de-bounce 18, timer 20, clock 24, computer 22, memory 28 and Comms RS232 26 and by using an algorithm. Using the timing of the triggering of the switches 44, the computer 22 and algorithm can calculate the times at which the bucket 40 tips and the volume of effluent 10 which is passing therethrough[ST1].

The MAX6817 de-bouncing circuit 18 conditions the relatively (electrically) noisy signal into something more acceptable to the micro-processor 22. Although it consumes power itself, this would be greatly outweighed by processor 22 activity needed to software de-bounce the switches 12, 14. It also absorbs transient energy, which may be picked up by antenna-like long wires contained within the cable 17 that physically connect the switches 12, 14.

The DS2404S is a real-time clock circuit 24 that has many desirable attributes, including very low power consumption and the ability to keep time in 256ths of a second.

The micro-processor or micro-controller 22 is an Atmel 89LS8252. This is also chosen to keep power consumption low. This micro-controller 22 has hardware support for a “sleep” (power down) mode, and “wake up” on interrupt (most other processors require a complete system reset to resume from power down). Since the device 2 will actually spend most of its time doing nothing, the ability to sleep is a positive advantage. This particular variant can also store data in non-volatile memory. In-system programmability eases software development.

Serial communications of the apparatus 1 is via DS276, which draws some power from the connected host. A printed circuit board used in the apparatus 1 is a mixed technology board using through-hole mounted as well as surface mounted devices.

Referring to FIGS. 5 and 6, there is shown a second embodiment of the tipping bucket 41 which is 3 m long and constructed out of 3 mm think galvanised mild steel and mounted on two pedestal bearings 70. The tipping bucket 41 has two elongate chambers 52,54 separated by a central wall 53 which extends along a longitudinal axis along the centre of the bucket 41 as indicated by arrows ‘A-A’ in FIG. 5. The bucket 41 is mounted in a tank 50 about bearings 70 such that it can pivot along the longitudinal axis ‘A-A’ of the bucket 41.

The arrangement shown in FIGS. 5 and 6 includes an inlet 6 along which the effluent 10 may pass into either chamber 52,54 of the bucket 41. Effluent 10 fills the chamber 52,54 until its weight causes the bucket 41 to pivot about bearings 70 until a stopper 62 underneath each chamber 52,54 contacts the base of the tank 50. Effluent 10 is then free to flow into the drainage channel 60 which leads to the sump 140 as shown in FIG. 9. The arrangement further includes a splash guard 58 to prevent splashing of the effluent 10.

In contrast to the first embodiment of the bucket 40 which uses tilt switches 44 to detect the position of the fluid 10 as it fills up the bucket 40, the second embodiment of the bucket 41 has a 2 g accelerometer 56 (supplied by Analogue Devices to Yorkshire Water Services) fitted onto the central wall 53. The accelerometer 56 measures movement of the tipping bucket 41 in order to estimate values for Tᵢ and dₜᵢ in Equation 1 of Protocol 4 of Appendix 2, and was fitted onto an ADXL202EB-232 evaluation board. The accelerometer 56 measures tilt, roll (angular position), and acceleration, and display this information on a computer through Crossbow software package supplied with the accelerometer 56. Angular position was recorded to measure the movement action of the tipping bucket 41 with time. This method records the movement about positive and negative X and Y-axis of the tipping bucket. However, before the accelerometer 56 could be used, it first required calibration as described in Appendix 2.

Referring to FIG. 7 there is shown apparatus 90 used for the calibration of the tipping bucket 41. The apparatus 90 consists of a platform ladder (not shown) of dimensions 1.5 m(w)×1.6 m(h)×0.5 m(d) which was modified to fit a support frame 80 from which a 50 kg capacity electronic spring balance 82 was suspended (±0.05 kg accuracy, manufactured by Graham and White, Weighmate 6050M). A 75-litre plastic storage vessel B was suspended from the spring balance 82 by a four-way 100 kg capacity wire lifting sling 88. Vessel B was supplied with water via a hose 84 from a 75-litre plastic storage vessel A (not shown). During field calibration, vessel A contained effluent 10 that has undergone settlement to remove gross solids. A double action, hand operated bilge pump 86 (manufactured by Plastimo, product number 11724) was used to lift the water (or effluent during field calibration) from Vessel A to Vessel B.

The method used for the calibration of the tipping bucket 41 is described in Protocol 4 of Appendix 2.

Referring to FIG. 8, there is shown a tipping bucket 41 which has been modified for calibration purposes. The tipping bucket 41 installed in the laboratory was modified so that the two chambers 52,54 had reduced volume. Two water tight aluminium bulkheads 100 were sealed in position approximately at the midpoint of the tipping buckets length in the chambers 52,54, as shown in FIG. 8. This left an unused area 102 of the two chambers 52,54. The rest of the apparatus 90 shown in FIG. 7 associated with the tipping bucket 41 remained unchanged. The calibration procedure was repeated (see Protocol 4, Appendix 2) on the reduced volume tipping bucket 41 in order to determine V_{bm} for the reduced length chamber 52,54.

Use of the Fluid Flow Measurement Apparatus 1—Syphon 4

1. Protocol 1 outlined in Appendix 2 was used for the calibration of the apparatus and the syphon 4 prior to operation.

2. The principle of operation of the flow measurement apparatus 1 is as follows:

As the water in the syphon container 4 as shown in FIG. 1 rises to the level of the lower float switch 14, the timer 20 is triggered. As the level of water 10 rises further and reaches the float switch 12, the timer 20 is triggered again. This time difference together with the data generated by the real-time clock 24, is stored in the memory 28 of the microprocessor 22, and is used by the algorithm of Appendix 1 to calculate the rate of rising of the liquid 10 in the container 4. Using the knowledge of the dimensions of the syphon and the container 4, the microprocessor 22 calculates the total daily flow of water 10 into and out of the syphon container 4.

3. The following is a description of one cycle of operation of the apparatus 1, taken from the point that the syphon container 4 is filling and has already covered the lower switch 14, with the level still rising.

Upper Switch 12—Covered

When the water 10 level reaches the upper switch 12, a note is made of the time. No further action is required. The syphon 4 continues to fill, until it is eventually activated, and then begins to empty.

Upper Switch 12—Uncovered

The level of water 10 will then drop until it uncovers the upper switch 12. A note is made of the time. No further action is required. The syphon container 4 is draining down.

Lower Switch 14—Uncovered

When the water 10 level uncovers the lower switch 14, a note is made of the time. No further action is required. The syphon container 4 continues to drain down until empty and then commences re-filling.

Lower Switch 14—Covered

It is at this point in the cycle that all the data required to make the various calculations is available.

Special Case—Upper Switch 12 Covered With Lower Switch 14 Uncovered

This condition should not occur in normal operation, and is used to enter test mode.

The time difference between covering the lower switch 14 in the previous cycle, and covering the upper switch 12 gives the filling time, tᵤᵢ[1]. The time difference between covering the lower switch 14 in the previous cycle and covering the lower switch 14 in this cycle gives the cycle time, t_{ci}[1]. The time ratio is t_{ci}/tᵤᵢ, assuming constant flow within the cycle period.

In practice a comparison is made between the filling time (lower switch 14 to upper switch 12), and time taken to subsequently uncover the upper switch 12, i.e. to complete filling and begin to drain down again. When the later is greater than twice the filling time the excess is ignored. A similar comparison is made for the time between emptying (lower switch 12 uncovered) and re-filling (lower switch 12 covered). The time for this should not be longer than one filling time (tᵤᵢ), and any excess is ignored for the calculation of cycle time (t_{ci}). These two adjustments are intended to correct for gross errors arising during periods of zero flow.

In any event, the ratio of (t_{ci}/tᵤᵢ) is added in to a running sum for the day. When this running total is multiplied by the stored volume (Vol) of the syphon container 4, the daily-totalised flow volume may be calculated. One cycle always straddles midnight, and the flow associated with that cycle is pro-rata apportioned to each day.

No provision has been made for cycles that straddle more than two days, as this is deemed an impractical proposition. Furthermore, although the gross errors associated with zero flow have been addressed to some extent, no attempt has been made to improve accuracy by handling changing flows in this version.

Advantages of the flow measurement device 2 consisting of the syphon 4 reside in that the switch array consisting of the upper 12 and lower 14 float switches and data logging apparatus estimates water 10 flow rates which closely resembles those recorded by a water meter with a noticeably lower deviation over a short period. This was in the order of minutes. This was due to the one second accuracy of the data logging. Over long periods (in the order of hours), the mean absolute error for the larger tank volume test run was 1.95%, the worst error being 3.89%. For the smaller tank volume tests, the mean absolute error was 4.56%, the worst error being 6.16%. Accordingly, this is substantially lower than the ±8% accuracy required by the environment agency where the Daily Totalised Flow Volume is submitted to be greater than 5 m³.

The device's 2 suitability in the field is preferred in terms of maintenance and installation. It is recommended that in order to improve its accuracy, the switch 12, 14 levels should be placed further apart in order to maximise the stored volume. An improved performance results if the average time to fill the stored volume increases.

The flow measurement device 2 is portable and battery powered and is sealed for life, so power consumption is a priority. It takes the two switches 12,14 as it's primary inputs and is able to operate with a sleep mode. It is able to communicate with a PC 22 or similar processing unit, and possesses sufficient resources in terms of processing ability, program and data storage, to be able to carry out the algorithm. Low cost, ease of build etc. also applies.

Use of the Fluid Flow Measurement Apparatus Using Tipping Buckets 40,41

Protocol 2 (single-sided tipping buckets 40), Protocol 3 (double-sided tipping buckets 41) and Protocol 4 (double-chambered buckets 41) were used for tipping bucket 40,41 apparatus calibration prior to operation.

Steady Flow Tests Using the Tipping Bucket 41 Apparatus

Steady flow tests were carried out for both full and reduced length chambers of the double-sided tipping bucket 41. These tests were carried out in order to determine the suitability of the application of equation 3, and to ascertain any uncertainty in the estimation of flow discharge for double sided tipping buckets 41 at varying discharges and bucket volumes. The results in Table 5 for the tipping bucket 41 at full chamber length suggest that an error in the timing of the value for dₜᵢ may have been made, i.e. the value determined for dₜᵢ was too low.

TABLE 5
Results for the initial steady flow tests at full
chamber length

| | | Estimated | |
|---|---|---|---|
| Flow | | Flow | Discharge |
| Discharged | | Discharged | Error |
| (Q) l/s | | (l) | (%) |
| 0.295 | | 0.281 | −4.75 |
| 0.381 | | 0.37 | −2.88 |
| 0.491 | | 0.471 | −4.24 |
| 0.598 | | 0.582 | −2.67 |
| 0.708 | | 0.679 | −4.10 |
| 0.805 | | 0.786 | −2.36 |
| 0.919 | | 0.89 | −3.15 |
| 1.01 | | 0.979 | −3.07 |
| 1.107 | | 1.081 | −2.35 |
| 1.235 | | 1.189 | −3.72 |
| 1.326 | | 1.298 | −2.11 |
| 1.418 | | 1.387 | −2.18 |
| 1.506 | | 1.458 | −3.19 |
| 1.6 | | 1.571 | −1.81 |
| 1.703 | | 1.671 | −1.88 |
| 1.8 | | 1.735 | −3.61 |
| dt_{I} (s) = | 0.9 | Mean Error | −3.19 |
| V_{bm} (l) = | 47 | | |

From table 5 it can be seen that all calculated values of discharge are underestimates (using equation 3). These results suggest that an error in the timing of the value for dₜᵢ may have been made, i.e. the value determined for dₜᵢ was too low.

Referring to FIG. 14, there is shown a plot of cycle time versus flow rate and the magnitude of the error of the predicted discharge associated with the corresponding flow rate. As can be seen from FIG. 14, the magnitude of the error appears to reduce slightly as flow rate increases. This supports the concept that the value of dt used was slightly underestimated.

TABLE 6
Results from the initial steady flow tests at half
chamber length

| | | Estimated Flow | |
|---|---|---|---|
| Flow Discharged | | Discharged | Discharge Error |
| (Q) l/s | | (l) | (%) |
| 0.297 | | 0.289 | −2.69 |
| 0.386 | | 0.372 | −3.62 |
| 0.49 | | 0.473 | −3.46 |
| 0.592 | | 0.59 | −0.34 |
| 0.696 | | 0.685 | −1.58 |
| 0.802 | | 0.793 | −1.12 |
| 0.915 | | 0.894 | −2.30 |
| 1.007 | | 0.988 | −1.87 |
| 1.106 | | 1.081 | −2.26 |
| 1.21 | | 1.184 | −2.15 |
| 1.279 | | 1.262 | −1.33 |
| 1.391 | | 1.363 | −2.01 |
| 1.5 | | 1.454 | −3.06 |
| 1.565 | | 1.543 | −1.41 |
| 1.65 | | 1.618 | −1.94 |
| 1.704 | | 1.69 | −0.82 |
| Dtᵢ (s) = | 0.9 | Mean Error | −1.98 |
| V_{bm} (l) = | 38.38 | | |

From Table 6, again all the calculated errors of discharge are too low (by equation 3). This also suggests that the value determined for dₜᵢ was indeed too low.

Referring to FIG. 15, there is shown a plot of cycle time versus flow rate and the magnitude of the error of the predicted discharge associated with the corresponding flow rate. Again as can be seen from FIG. 15, the magnitude of error decreases slightly as flow rate increases.

Steady Flow Test Conclusions

The results of the steady flow tests have shown that the use of a tipping bucket 41 is an effective method for calculating discharge with accuracy better than ±4.75%. Due to the estimation of discharge being consistently less than the actual observed discharge value (by equation 1) it is suggested that the value for dₜᵢ be increased, in order to give a closer estimate of actual discharge in accordance with observed discharge values. The reduced length chamber bucket 41 produced smaller errors than the larger volume bucket 41. In this case this tipping bucket 41 configuration was able to estimate discharge to an accuracy of ±3.62%.

Time Varying Flow Tests

Time varying flow tests were carried out for both full and reduced length chambers of the double sided tipping bucket 41, the hydrographs selected were based on a water usage profile scaled to population equivalents. These tests were undertaken to ascertain the suitability of the data logged from the accelerometer. Table 7 shows the details of the time varying flow tests that were carried out on the full and reduced chamber length double sided tipping bucket 41. It was decided to complete the full range of tests on the full length chamber tipping bucket 41 as this configuration was shown to produce the greater errors in the prediction of discharge (see Table 5). The single test using the reduced length chamber tipping bucket 41 examined the potential change in accuracy if a reduced chamber length bucket was used.

TABLE 7
Time varying flow tests undertaken on the full
and reduced chamber length double sided tipping bucket

| | | | Length |
|---|---|---|---|
| Test | Population | Duration | of |
| Number | equivalent | (Hrs) | bucket |
| 1 | 87.5 | 8 | Full |
| 2 | 263 | 8 | Full |
| 3 | 263 | 8 | Half |
| 4 | 525 | 8 | Full |

As shown in Table 7 each test was of approximately 8 hours in duration. Referring to FIG. 9, the valve control software 130, used during the steady flow tests, was also used during the time varying flow tests, with the digital signal from the flow meter 124 being recorded via the data acquisition software 128 in order to continuously monitor the flow discharge. In addition to the discharge being continuously monitored a mechanical counter was also installed on the tipping bucket 41 apparatus in order to visually log the number of completed cycles in a given time period. The discharge data from the data acquisition software 128 combined with the mechanical counter allowed the accuracy in the predictions for DTFV over longer time periods to be determined.

Referring to FIG. 16, there is shown a plot of the peak discharge flow rate data against time from the data acquisition software for the three different population equivalents. The plot shows that identical discharge flow rate patterns were used during the 8 hour time varying flow tests for the different population equivalents and for the full and reduced chamber length double sided tipping bucket 41.

For the purpose of the time varying flow tests DTFV was calculated by filtering the logged data from the accelerometer 56 using Microsoft Excel, to estimate the times at which the angular displacement was at its peak, so as to gain an approximate value for the varying cycle times to be substituted into equation 2 along with the previously determined constant value for dₜᵢ. This method of approximation allowed us to determine a value for DTFV over the eight hour period against the discharge flow data gained from the data acquisition software. It was seen that DTFV could be determined to an accuracy of at least ±5.25% in these tests.

TABLE 8
Errors in DTFV for time varying flow tests for
full and reduced length chamber volumes

| | | Measured | Estimated | Discharge |
|---|---|---|---|---|
| Chamber | Population | Volume | Volume | Error |
| Length | Equivalent | (l) | (l) | (%) |
| Full | 87.5 | 5765 | 5642 | 5.24 |
| Full | 263 | 17550 | 17406 | 0.82 |
| Full | 525 | 34656 | 34843 | 0.5 |
| Reduced | 263 | 17430 | 17543 | 0.65 |

Time Varying Flow Test Conclusions.

The results of the time varying flow tests show that DTFV can be estimated for the tipping bucket 41 installed within the laboratory to an accuracy of at least ±5.25% using equation 2 and the constant value for dₜᵢ gained from the steady flow tests described in section 2. The results in table 8 also show that the pattern of errors follows that of the steady flow tests, in that error decreases significantly as flow rate increases. The errors for the reduced volume bucket 41 are smaller than for the full length bucket, this is also in accordance with the results of the steady flow tests.

Appendix 1

The following sections detail the current state of development of the software used for controlling the apparatus 1. Some code below is experimental, and subsequently may not be included in the final design.

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

APPENDIX 2

PROTOCOL 1

Step 1—Assessment of Suitability of in-situ Syphon 4 for Measurement of Flow Volume

By visual inspection, an operative should ensure that:

i) all water 10 flow passing through the plant passes through the syphon 4.

ii) the syphon 4 does not show signs of being overtopped/drowned during periods of high flow rate; and

iii) the syphon's 4 mechanism is mechanically sound.

If any of the above criteria are not met, it should either be remedied or the installation deemed unsuitable for use in the measurement of DTFV.

Step 2—Calibration of Mean Stored Volume of Syphon 4

i) To establish the stored volume in the syphon 4, it is necessary to measure the volume that collects between two water level switches 12,14. Therefore, the syphon 4 should be allowed to fill to the point where the syphon 4 activates and discharges. Any residual volume of water 10 left in the syphon 4 underneath the lower switch 14 should not be removed.

ii) The flow of water 10 is diverted directly onto the filter bed as soon as the syphon 14 has finished discharging, for example by using a flexible pipe. The syphon 4 is clamped to prevent movement.

iii) The syphon 4 is filled slowly until the first switch 14 is activated.

iv) As soon as the first switch 14 has been activated, the syphon 4 should then be filled slowly with a measured volume of water 10 to the point where the second switch 12 is activated. This volume is termed the stored volume and is denoted as Vₛ.

v) Step iv) should be repeated 3 times to establish 3 values of Vₛ.

vi) Calculate the mean value of Vₛ. This mean value is denoted as Volₛ.

vii) For each value of Vₛ, calculate Z (percentage) from Equation 2i below;

$$Z = ( \frac{{V}_{S} - {Vol}_{S}}{{Vol}_{S}} ) \times 100 \qquad \text{2i}$$

viii) If absolute values of all Z are less than 1% then proceed to Step 3.

ix) Discard value of Vₛ with the largest deviation from the mean and repeat step iii), v), vi) and vii). Ensure that all values of Z are re-calculated as the value of Volₛ has changed.

Step 3—Monitoring Syphon 4 Operation and Calculating DTFV

During a single day, the time of each operation of the syphon 4 should be recorded (from the same point during each cycle, ie the time at which either the upper 12 or lower switch 14 is activated). This will establish a series of syphoning times, tᵢ, for i=1 to N, where N is the number of cycles in the day.

From this series a corresponding series of cycle periods t_{ci} can be established using Equation 3i for c=1 to N−1.

t_{ci}tᵢ−tᵢ₋₁ 3i

The time for the water level to rise between the switches 12,14 during each cycle I (tᵤᵢ), needs to be recorded.

The series of t_{ci} and tᵤᵢ can be used in Equation 3ii to calculate DTFV i.e. the daily totalised flow volume passing through the syphon 4.

$$DTFV = {\sum }_{i = 1}^{N} ( ( \frac{{Vol}_{S}}{{t}_{ui}} ) \times {t}_{ci} ) \qquad \text{3ii}$$

NOTE—This procedure assumes that flowrate is approximately constant during the period of each cycle, t_{ci} (but not from cycle to cycle). This is a valid assumption given the large volume of the tanks which commonly supply filter beds at small WwTW in comparison with the flowrate passing through them.

PROTOCOL 2

Step 1—Assessment of Suitability of in-situ Tipping Bucket 4 for Measurement of Flow Volume

By visual inspection, the operative should ensure that;

i) all flow passing through the plant passes through the tipping bucket 4,

ii) the bucket does not show signs of being overtopped/drowned during periods of high flowrate,

iii) the bucket does not hold significant volumes of sediment,

iv) the tipping mechanism is mechanically sound.

If any of the above criteria are not met, it should either be remedied or the installation deemed unsuitable for use in the measurement of DTFV.

Step 2—Calibration of Mean Tip Volume of Single-Sided Tipping Bucket

i) Divert flow directly onto filter bed, for example by using a flexible pipe, ensuring that the motion of the tipping bucket is not impeded.

ii) Remove debris from bucket. Pressure wash if necessary.

iii) To establish volume per tip from the bucket, it is necessary to account for any volume that remains in the bucket after it has tipped. Therefore, the bucket should be filled to the point where the bucket tips and discharges. Any residual volume of water left in the bucket should not be removed.

iv) With the tipping bucket at rest following discharge, the bucket should be filled slowly with a measured volume of water to the point where the bucket tips and discharges. This volume is denoted as V_{b}.

v) Step iv) should be repeated 3 times to establish 3 values of V_{b}.

vi) Calculate the mean value of V_{b}. This mean value is denoted as V_{bm}.

vii) For each value of V_{b}, calculate Z (percentage) from Equation 2i below;

$$Z = ( \frac{{V}_{b} - {V}_{bm}}{{V}_{bm}} ) \times 100 \qquad \text{2i}$$

viii) If absolute values of all Z are less than 1% then proceed to Step 3.

ix) Discard value of V_{b} with the largest deviation from the mean and repeat step iv), vi), vii) and viii). Ensure that all values of Z are recalculated as the value of V_{bm} has changed.

Step 3—Monitoring Single-Sided Tipping Bucket Operation and Calculating DTFV

During a single day, the time of each operation of the tipping bucket should be recorded (for the same point during each tipping cycle). This will establish a series of tipping times, tⱼ, for j=1 to n, where n is the number of tips in the day.

From the series tⱼ, a corresponding series of cycle periods, Tⱼ, can be established using Equation 3i for j=1 to n−1.

Tⱼ=tⱼ−tⱼ₊₁ 3i

The tipping time dₜⱼ, i.e. the time period when the bucket is moving during each tipping cycle, needs to be recorded. The series of Tⱼ and dₜⱼ can be used in Equation 3ii to calculate DTFV₁ i.e. the daily totalised flow volume passing through a one-sided tipping bucket.

$${DTFV}_{1} = {V}_{bm} {\sum }_{j = 1}^{n} ( \frac{T}{{T}_{j} - {dt}_{j}} ) \qquad \text{3ii}$$

NOTE—This procedure assumes that flowrate is approximately constant during the period of each cycle, Tⱼ(but not from cycle to cycle). This is a valid assumption given the large volume of the balancing tanks that commonly supply filter beds at small WwTW in comparison with the flowrate passing through them.

PROTOCOL 3

Step 1—Assessment of Suitability of in-situ Double-Sided Tipping Bucket for Measurement of Flow Volume

Step 1 is as for single-sided tipping buckets.

Step 2—Calibration of Mean Tip Volume of Buckets

i) Divert flow directly onto filter bed, for example by using a flexible pipe, ensuring that the motion of the tipping bucket is not impeded.

ii) Remove debris from both buckets. Pressure wash if necessary.

iii) To establish volume discharged per tip from each of the two buckets it is necessary to account for any volume which remains in the bucket after it has tipped. Therefore each side should be filled in turn to the point where the bucket tips and discharges. Any residual volume of water left in the buckets should not be removed.

iv) With the tipping bucket at rest on one side, the other side should be filled slowly with a measured volume of water to the point where the bucket tips and discharges. This volume is denoted as V₁.

v) The tipping bucket will now be in a position whereby the procedure can be repeated to establish the volume for the other side, denoted as V₂.

vi) Steps iv) and v) should be repeated 3 times to establish 3 values for V₁ and V₂.

vii) Calculate the mean values of V₁ and V2. These mean values are denoted as V₁ₘ and V₂ₘ respectively.

viii) For each value of V₁, calculate X (percentage) from Equation 2i below;

$$X = ( \frac{{V}_{1} - {V}_{1 m}}{{V}_{1 m}} ) \times 100 \qquad \text{2i}$$

ix) For each value of V₂, calculate Y (percentage) from Equation 2ii below;

$$Y = ( \frac{{V}_{2} - {V}_{2 m}}{{V}_{2 m}} ) \times 100 \qquad \text{2ii}$$

x) If absolute values of all X and Y are less than 1% then proceed to xii.

xi) Discard values of V₁ and V₂ with the largest deviation from the mean and repeat step iv), v) and vii) to x). Ensure that all values of X and Y are recalculated as the values of V₁ₘ and V₂ₘ have changed.

xii) The mean tip volume of the buckets (i.e. the volume corresponding to 2 tips, one from each bucket) is the sum of V₁ₘ and V₂ₘ as given by Equation 2iii.

V_{bm}=V₁ₘ+V₂ₘ 2iii

Step 3—Monitoring Tipping Bucket Operation and Estimating DTFV

The estimation of DTFV from a two sided bucket is affected by potential errors that occur if flow continues to enter a bucket as it is tipping and discharging. The following estimations of DTFV assumes two cases; one in which water continues to enter a bucket as it tips and discharges.

This produces an estimate for the maximum possible DTFV (DTFV_{2MAX}). The other case assumed is one in which no water is assumed to enter a bucket as it tips and discharges (DTFV_{2MIN}). In reality the actual DTFV₂ is likely to be closer to the DTFV_{2MAX} estimate as it accounts for errors caused by flow entering the bucket as it discharges. During a single day, the duration that the tipping bucket is in motion (dₜᵢ) for each cycle of operation should be recorded along with the duration of each cycle of operation (Tᵢ). The number of cycles in a day (N) can be determined from this information.

Estimation of DTFV_{2MIN}

In the calculation of DTFV_{2MIN} it is assumed that no flow enters a bucket as it is discharging. This is believed to be the most likely scenario in the field and can be checked by visual observation of the tipping bucket in operation. If this is the case DTFV_{2MIN} can be estimated from equation 3i.

DTFV_{2MIN}=NV_{bm} 3i

Estimation of DTFV_{2MAX}

In the calculation of DTFV_{2MAX} it is assumed that flow continues to enter a bucket as it tips and discharges. This assumption ensures that the maximum possible flow volume is calculated. This procedure assumes that flowrate is approximately constant during the period of each cycle, Tᵢ (but not from cycle to cycle). This is a valid assumption given the large volume of the balancing tanks that commonly supply filter beds at small WwTW in comparison with the flowrate passing through them. The DTFV_{2MAX} is estimated using equation 3ii.

$${DTFV}_{2 MAX} = {V}_{bm} {\sum }_{i = 1}^{N} ( \frac{{T}_{i}}{{T}_{i} - {dt}_{i}} ) \qquad \text{3ii}$$

PROTOCOL 4

Assessment of Suitability of Double-Chambered Tipping Bucket for Measurement of Flow Volume

The aim of the work using the double-chambered tipping bucket 41 was to monitor the Daily Totalised Flow Volume (DTFV), which passes through small wastewater treatment works. This was achieved by determining a volume constant for the tipping bucket chamber 52,54 known as V_{bm}, and then measuring the cycle time for the bucket 41 to operate (Tⱼ), and the time the bucket 41 is in motion during each cycle (dₜᵢ). The time the bucket 41 was in motion was measured by the accelerometer 56. Then by applying this information to equations, 1, 2 and 3 below, to estimate DTFV. Equation 1 is used to determine the volume discharged (Vₒᵢ) during one single cycle of operation of the tipping bucket 41.

$${V}_{oi} = {V}_{bm} ( \frac{T}{{T}_{i} - {dt}_{i}} ) \qquad Equation 1$$

Where T is the overall cycle time of the tipping bucket 41, dt is the time duration in which the tipping bucket 41 is in motion during the cycle, and i is the cycle number. V_{bm} is the volumetric calibration constant for the bucket 41, it represents the difference in volume when the bucket 41 is full, and of the water (effluent 10) left in the bucket 41 once it has tipped. This needs to be determined for individual tipping buckets 41 using a determined measured protocol.

Equation 2 is used to determine the maximum daily-totalised flow volume (DTFVmax).

$$DTFV = {V}_{bm} {\sum }_{i = 1}^{N - 1} ( \frac{{T}_{i}}{{T}_{i} - {dt}_{i}} ) \qquad Equation 2$$

Where N is the number of completed cycles.

Equation 3 is used to estimate flow rate discharge (Q) into the tipping bucket 41 from rearrangement of equation 1.

$${Q}_{i} = \frac{{V}_{oi}}{{T}_{i}} = {V}_{bm} \cdot \frac{1}{{T}_{i}} \cdot ( \frac{{T}_{i}}{{T}_{i} - {dt}_{i}} ) \qquad Equation 3$$

Where Qi=flow rate discharged into the tipping bucket 41.

Calibration of Double-Chambered Tipping Bucket

The aim of the calibration procedure is to determine a volumetric calibration constant (V_{bm}) that can be applied to equations 1, 2 and 3 mentioned above to determine values for DTFV. V_{bm} is determined by discharging known volumes of water, in order to activate the tipping bucket 41. The calibration procedure was set out in an earlier document Protocol 3 (Step 2, page 74).

The tipping bucket 41 consisted of the two chambers 52,54, one on either side of the central wall 53. Each chamber 52,54 was filled with clean water until it discharged to allow each side of the chamber to become “wetted”. This was done to allow for any residual water present after discharge. In turn each chamber 52,54 of the tipping bucket 41 was filled with clean water from Vessel B (by controlling the inflow from a valve attached to the rigid pipe 84), until the bucket 41 discharged. This process was repeated three times, and the mass and therefore the volume of water to tip the bucket 41 recorded.

Equations 4 and 5 below were used to determine the percentage error associated with the volume of each chamber V₁ (52) and V₂ (54). Where V₁ₘ and V₂ₘ are the mean chamber volumes of the double sided tipping bucket 41. These values are shown in table 1.

$$\begin{matrix}X = ( \frac{{V}_{1} - {V}_{1 m}}{{V}_{1 m}} ) \times 100 & Equation 4 \\ Y = ( \frac{{V}_{2} - {V}_{2 m}}{{V}_{2 m}} ) \times 100 & Equation 5\end{matrix}$$

TABLE 1
Chamber volumes recorded during calibration with
associated error values for the double sided Tipping
Bucket set at full chamber volume

| Measurement | V₁₍₁₎ | V₂₍₁₎ | Error | Error |
|---|---|---|---|---|
| No. | (litres) | (litres) | X (%) | Y (%) |
| A | 23.42 | 23.80 | 0.141 | 0.919 |
| B | 23.40 | 23.45 | 0.073 | 0.565 |
| C | 23.40 | 23.50 | 0.073 | 0.353 |
| Mean chamber | 23.41 | 23.58 | | |
| volume (V_{bm}) | | | | |

The calibration protocol states that as values of X and Y are below 1% for all values of V₁ and V₂, the measured mean chamber volume for the tipping bucket V_{bm} can be used in equations 1 and 2, and is given by the sum of V₁ₘ+V₂ₘ.

V_{bm}=46.99 litres.

Again Equations 4 and 5 were used to determine the percentage error associated with the volume of each chamber V₁ and V₂. Where V₁ₘ and V₂ₘ are the mean chamber volumes of the reduced volume double sided tipping bucket 41. These values are shown in tables 1 and 2.

$$\begin{matrix}X = ( \frac{{V}_{1} - {V}_{1 m}}{{V}_{1 m}} ) \times 100 & Equation 4 \\ Y = ( \frac{{V}_{2} - {V}_{2 m}}{{V}_{2 m}} ) \times 100 & Equation 5\end{matrix}$$

TABLE 2
Chamber volumes recorded during calibration with
associated error values for the double sided Tipping
Bucket at reduced chamber volume.

| Measurement | V₁₍₂₎ | V₂₍₂₎ | Error | Error |
|---|---|---|---|---|
| No. | (litres) | (litres) | X (%) | Y (%) |
| A | 19.67 | 18.55 | 0.037 | 0.050 |
| B | 19.65 | 18.60 | 0.010 | 0.050 |
| C | 19.65 | 18.70 | 0.042 | 0.050 |
| Mean chamber | 19.66 | 18.62 | | |
| volume (V_{bm}) | | | | |

The calibration protocol states that as values of X and Y are below 1% for all values of V₁ and V₂, the mean discharge volume for the tipping bucket at half chamber volume V_{bm}, is given by the sum of V₁ₘ+V₂ₘ.

V_{bm}=38.28 litres.

The calibration protocol and procedure for the use on tipping buckets has proved to be simple to implement. The procedure should lend itself easily to field application.

Due to ease of set-up of the calibration equipment and of the simplicity in determining V_{bm}, the complete procedure took a single operator only 1 hr15 mins to complete for each configuration of the tipping bucket.

Experimental Tests

For the double sided tipping bucket 41 at full and reduced length configurations, a range of steady flow tests were undertaken to ascertain the suitability of equations 1, 2 and 3 to estimate actual discharge. A range of time variable flow tests based on average population sizes were undertaken in order to ascertain the suitability of the logged data from the accelerometer 56 to estimate total flow volume discharged.

TABLE 3
Steady flow tests undertaken on the full and
reduced length double sided tipping bucket

| | Steady |
|---|---|
| | flowrate tests |
| | for |
| | Double sided |
| | full length |
| | tipping |
| | bucket |
| Test | (l/s) |
| 1 | 0.295 |
| 2 | 0.381 |
| 3 | 0.491 |
| 4 | 0.598 |
| 5 | 0.708 |
| 6 | 0.805 |
| 7 | 0.919 |
| 8 | 1.01 |
| 9 | 1.107 |
| 10 | 1.235 |
| 11 | 1.326 |
| 12 | 1.418 |
| 13 | 1.506 |
| 14 | 1.6 |
| 15 | 1.703 |
| 16 | 1.8 |
| 17 | 0.297 |
| 18 | 0.386 |
| 19 | 0.49 |
| 20 | 0.592 |
| 21 | 0.696 |
| 22 | 0.802 |
| 23 | 0.915 |
| 24 | 1.007 |
| 25 | 1.106 |
| 26 | 1.21 |
| 27 | 1.279 |
| 28 | 1.391 |
| 29 | 1.5 |
| 30 | 1.565 |
| 31 | 1.65 |
| 32 | 1.704 |

TABLE 4
Time varying flow tests undertaken on the full
and reduced length double sided tipping bucket

| Test | Population | Duration | Length of |
|---|---|---|---|
| Number | equivalent | (Hrs) | bucket |
| 33 | 87.5 | 8 | Full |
| 34 | 263 | 8 | Full |
| 35 | 263 | 8 | Half |
| 36 | 525 | 8 | Full |

Calibration of the Accelerometer 56

Before data can be logged from the accelerometer 56 it required calibration. The accelerometer 56 was connected to a P.C. in order to draw power. Then a connection has to be established with the supplied Crossbow software. An automatic calibration routine was run which requires the user to steadily rotate the accelerometer 56 through 360° in both the X and Y-axis. Following this routine logging of data can begin.

Angular position values were sampled at a frequency of 144 Hz. In each steady flow test ten complete tipping cycles were recorded. The accelerometer 56 was mounted on the central wall 53 of the tipping bucket 41 in order to measure angular position of equal, but opposite sign. For each tip of the double sided bucket 41.

For the purposes of estimating DTFV during the steady and time varying flow tests undertaken in the laboratory the accelerometer 56 was connected to a PC running the Crossbow software. This software allows the signal logged from the accelerometer 56 to be displayed in real time and also for the data to be saved and downloaded directly to a file on the computer for further processing when the test is completed.

For the time varying flow tests the accelerometer data was sampled at 144 Hz and the data recorded for the 8 hour duration of each test.

Referring to FIG. 10, there is shown data collected from the accelerometer 56 during a single tip with the double sided full length tipping bucket 41 and a steady flow rate of 1.6 litres per second.

FIG. 10 indicates the different types of motion within a single cycle of the tipping bucket 41. The bucket 41 is initially at rest, and the angular position has a constant value, the bucket 41 starts to move and accelerates to a new position. The angular position changes increasingly rapidly until the tipping bucket 41 hits the stops 62 and the bucket 41 bounces, producing a series of diminishing peaks in angular position. Once the bucket 41 is at rest it now has a stable but different value of angular position, from the start of the cycle.

Estimation of DTFV via equation 2 relies on accurate temporal information interpreted from the accelerometer 56 signal. As with the value of V_{bm} accuracy in the estimation of dt is important for the reliable determination of discharge. The region of motion of the tipping bucket 41 is from first movement to contact with the stoppers 62. From this point onwards the tipping bucket 41 is “bounces” against the stops. The highlighted area (box X) in FIG. 10 is taken as the value of dₜᵢ. Referring to FIG. 11, there is shown angular position against time for a double sided tipping bucket 41 showing maximum flow rate plot for full length bucket 41, and minimum flow rate for reduced length tipping bucket 41. FIG. 11 shows that the tipping operation of the bucket 41, in terms of angular displacement, is similar regardless of flow rate (Q) or tipping bucket 41 chamber length. This suggests that the value of dₜᵢ could be considered as a constant for input into equation 3 for the double sided tipping bucket 41 installed within the laboratory.

For the purpose of the experimental tests carried out in the laboratory, dₜᵢ was estimated by using Microsoft excel to look for relative changes in angular position (increasing or decreasing over a specified number of data entries within a time period), and the times associated with the change. By using this approximate method an estimate of dₜᵢ for individual cycles could be obtained. It was found that the values of dₜᵢ were similar for the lowest and highest flow rates, and for the full and reduced chamber length tipping buckets (see FIG. 12).

From the method of analysis described above and due to the value of dₜᵢ being similar for all the steady flow tests carried out within the laboratory, the value of dₜᵢ was considered as a constant of 0.9 seconds for input into equations 1 and 2, in order to calculate Vₒᵢ and DTFV.

The estimation of the cycle time (T) was achieved by examining the data logged from the accelerometer 56 for a number of cycles. A cycle time was taken to be the time duration between consecutive peaks of angular position, i.e when the tipping bucket 41 first hit the stops 62. Cycle times were found to be reasonably consistent, to an accuracy of ±0.5 seconds (see FIG. 13). For the estimation of DTFV (see equation 2) during the steady flow tests carried out on the double sided tipping bucket 41 at both full and reduced chamber lengths, mean values for Tᵢ were used.

The reader's attention is directed to all papers and documents which are filed concurrently with or previous to this specification in connection with this application and which are open to public inspection with this specification, and the contents of all such papers and documents are incorporated herein by reference.

All of the features disclosed in this specification (including any accompanying claims, abstract and drawings), and/or all of the steps of any method or process so disclosed, may be combined in any combination, except combinations where at least some of such features and/or steps are mutually exclusive.

Each feature disclosed in this specification (including any accompanying claims, abstract and drawings), may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of the foregoing embodiment(s). The invention extend to any novel one, or any novel combination, of the features disclosed in this specification (including any accompanying claims, abstract and drawings), or to any novel one, or any novel combination, of the steps of any method or process so disclosed.

1. Apparatus for measuring the volume of a fluid passing through a container, the apparatus comprising first and second fluid level detection means which detection means are operable to detect the presence of said fluid at first and second levels in the container respectively, timing means operable to determine a time of triggering of said first and second fluid detection means, and processing means operable to determine the volume of fluid flowing through the container, based on output of the first and second fluid detection means and said timing means.

2. An apparatus according to claim 1, wherein the container comprises a syphon.

3. An apparatus according to claim 1, wherein the first detection means comprises a lower switch and the second fluid detection means comprises an upper switch, which switches are operable to detect the level of fluid in the container.

4. An apparatus according to claim 1, wherein the first and second detection means are suitably mounted onto a shaft which is arranged in use substantially vertical in the container.

5. Apparatus for measuring the volume of a fluid passing through a syphon, the apparatus comprising upper and lower switches which switches are operable to detect the presence of said fluid at upper and lower levels in the syphon respectively, a timer operable to determine a time of triggering of said upper and lower switches, and a computer operable to determine the volume of fluid flowing through the syphon, based on output of the upper and lower switches and said timer.

6. A method of measuring the volume of fluid flowing through a container, the method comprising the steps of:
(i) detecting times at which fluid in the container reaches first and second levels during filling;
(ii) detecting times at which the fluid in the container reaches either the first or second level during a subsequent filling cycle; and
(iii) computing volume throughput based on the measured times and volume of the container defined by the first and second levels.

7. A method according to claim 6, wherein the container comprises a syphon.

8. A method according to either claim 6, wherein said detecting times comprises the use of first and second fluid level detection means, wherein the said first detection means comprises a lower switch and the second fluid detection means comprises an upper switch, which switches are operable to detect the level of fluid in the container.

9. A method according to claim 6, wherein the method comprises determining a filling time of the said container and determining a cycle time of the said container and determining the volume of the container.

10. A method according to claim 6, wherein the computing comprises determining the flow volume by multiplying the volume of the container by the total of the ratio of cycle time to filling time.

11. Apparatus for measuring the volume of a fluid passing through a container, the apparatus comprising container motion detection means which detection means is operable to detect motion of the container, and processing means operable to determine the volume of fluid flowing through the container, based on output of the container motion detection means.

12. Apparatus according to claim 11, wherein the container comprises at least one tipping bucket pivotable along an axis parallel with a longitudinal axis thereof.

13. Apparatus according to claim 11, wherein the container comprises first and second chambers separated by dividing means, which dividing means comprises a dividing wall which extends substantially parallel with a longitudinal axis of the container.

14. Apparatus according to claim 13, wherein the container is adapted to pivot between a first position in which the first chamber is filling with fluid, and a second position in which the first chamber is emptying fluid, and the second chamber is filling with fluid.

15. Apparatus according to claim 13, wherein the container motion detection means is suitably attached to the container on the dividing means.

16. Apparatus according to claim 11, wherein the container motion detection means is adapted to measure angular position of the container to determine movement of the container with respect to time.

17. Apparatus according to claim 11, wherein the container motion detection means is operable to determine the time of filling and the time of emptying the container.

18. Apparatus according to claim 11, wherein the container motion detection means comprises an accelerometer.

19. Apparatus for measuring the volume of a fluid passing through a tipping bucket, the apparatus comprising an accelerometer operable to detect motion of the tipping bucket, and a computer operable to determine the volume of fluid flowing through the tipping bucket, based on output of the accelerometer.

20. A method of measuring the volume of fluid flowing through a container, the method comprising the steps of:
(i) detecting motion of the container;
(ii) computing fluid volume throughput based on the detected motion of the container.

21. A method according to claim 20, wherein the method comprises determining angular position of the container to determine movement of the container with respect to time.

22. A method according to claim 20, wherein the method comprises determining the time of filling and the time of emptying the container and determining the volume of fluid filling the container as fluid exits the container.
